(19) United States
(12) Patent Application Publication
(10) Pub. No.: US 2008/0285507 A1
(43) Pub. Date: Nov. 20, 2008

(54) Independent Scheduling in a Wireless Network

(75) Inventors: Biswaroop Mukherjee, Ottawa (CA); Bill Gage, Stittsville (CA); Jerry Chow, Kanata (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 10/599,802

(22) PCT Filed: Apr. 28, 2005
(86) PCT No.: PCT/IB05/01150

§ 371 Date: Oct. 10, 2006

Related U.S. Application Data
(60) Provisional application No. 60/565,950, filed on Apr. 28, 2004.
(60) Provisional application No. 60/618,688, filed on Oct. 14, 2004.

(51) Int. Cl. H04Q 7/00; H04J 3/16

(52) U.S. Cl. 370/329; 370/328; 370/465; 455/452.1

(57) ABSTRACT

The present invention provides a scheduling technique that allows individual nodes in a wireless communication network to independently determine their own communication schedules. The communication nodes in the wireless communication network are associated with one or more compatible communication nodes through substantially non-contending communication links, wherein the communication links within a group of compatible communication nodes are substantially non-interfering. Each node will exchange scheduling information with the various compatible communication nodes, and determine the communication schedule for future communications with those compatible communication nodes. This communication schedule may dictate when information is received from or sent to a compatible communication node during a given transmission opportunity.

This application claims the benefit of provisional patent application Ser. No. 60/565,950, filed Apr. 28, 2004, and provisional patent application No. 60/618,688, filed Oct. 14, 2004, the disclosures of which are hereby incorporated by reference in their entireties.

### FIELD OF THE INVENTION

The present invention relates to wireless communications, and in particular to providing scheduling throughout a wireless network.

### BACKGROUND OF THE INVENTION

In a wireless mesh network where communication nodes share wireless communication resources to exchange information with their neighbors to facilitate communications, each communication node must determine a schedule to control transmission and reception between the various communication nodes to provide an appropriate throughput, minimize collisions, and perhaps provide one or more quality of service levels. The scheduling generally dictates the timing and sequence of communications between neighboring communication nodes. In a network with a plurality of autonomous communication nodes, there are numerous challenges to determining transmission and reception schedules for the various communication nodes.

If a centralized scheduling technique is implemented, each of the communication nodes must communicate with a central communication entity, which must process the various information and create schedules for the various communication nodes. These schedules must be downloaded to the various communication nodes. Unfortunately, it is difficult and time-consuming to implement centralized scheduling, especially when the centralized scheduling entity is a significant distance from certain of the communication nodes, thereby requiring the scheduling information itself to be forwarded through multiple communication nodes to get to an appropriate destination.

Another issue with scheduling is the need for each of the communication nodes to synchronize to a common time base. In most instances, the individual clocks that are maintaining the time base for each of the autonomous communication nodes will progress at slightly different rates and will drift away from each other over time. If a centralized clock is provided to which each of the communication nodes will synchronize, communication nodes that are outside of direct communication range with the centralized clock must have synchronization information propagated through any number of communication nodes. Again, valuable time and resources are spent in an effort to maintain synchronization throughout the communication network.

Accordingly, there is a need for a technique to provide scheduling for each of the communication nodes in a wireless communication network, without relying on a centralized scheduling entity. There is a further need to avoid the need for the various communication nodes to synchronize their internal clocks to a centralized clock.

### SUMMARY OF THE INVENTION

The present invention provides a scheduling technique that allows individual nodes in a wireless communication network to independently determine their own communication schedules. The communication nodes in the wireless communication network are associated with one or more compatible communication nodes through a shared communication medium. The present invention turns this shared medium into a set of substantially non-contending communication links, wherein the communication links within a group of compatible communication nodes are substantially non-interfering. Each node will exchange scheduling information with the various compatible communication nodes, and determine the communication schedule for future communications with those compatible communication nodes. This communication schedule defines a series of transmission opportunities and dictates when information is received from or sent to a compatible communication node during a given transmission opportunity. These transmission opportunities may vary in length or period.

Traffic scheduling for each compatible communication node is done in a serial fashion to avoid conflicting schedules. The communication schedule may include transmission opportunities for forwarding data traffic, for negotiating future scheduling, or for a combination thereof. Further, the communication schedule may include one or more schedules that provide transmission opportunities for any number of communication queues, which may be associated with different users, compatible communication nodes, quality of service levels, or any other desired parameter. The scheduling negotiations with the compatible communication nodes and the resultant communication schedule will take into consideration quality of service policies or requirements. In one embodiment, each of the communication nodes has an independent clock, which is not synchronized with the clocks of other compatible communication nodes or a common reference clock.

In other embodiments, three or more compatible communication nodes may share a given communication link, wherein a given transmission opportunity may be overloaded, such that a given packet of information may hop through multiple compatible communication nodes within a given transmission opportunity, or multiple packets may be received from or sent to a number of compatible communication nodes during a given transmission opportunity.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a wireless communication environment according to one embodiment of the present invention.

FIG. 2 is a block representation of communication links for four communication nodes according to one embodiment of the present invention.

FIG. 3 is a communication flow diagram illustrating the operation of the present invention according to one embodiment.

FIG. 4 is a timing diagram illustrating why the various communication nodes of the present invention do not need to rely on a common clock.

FIG. 5 is a block representation of a communication environment according to a second embodiment of the present invention.

FIG. 6 is a block representation of a communication node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

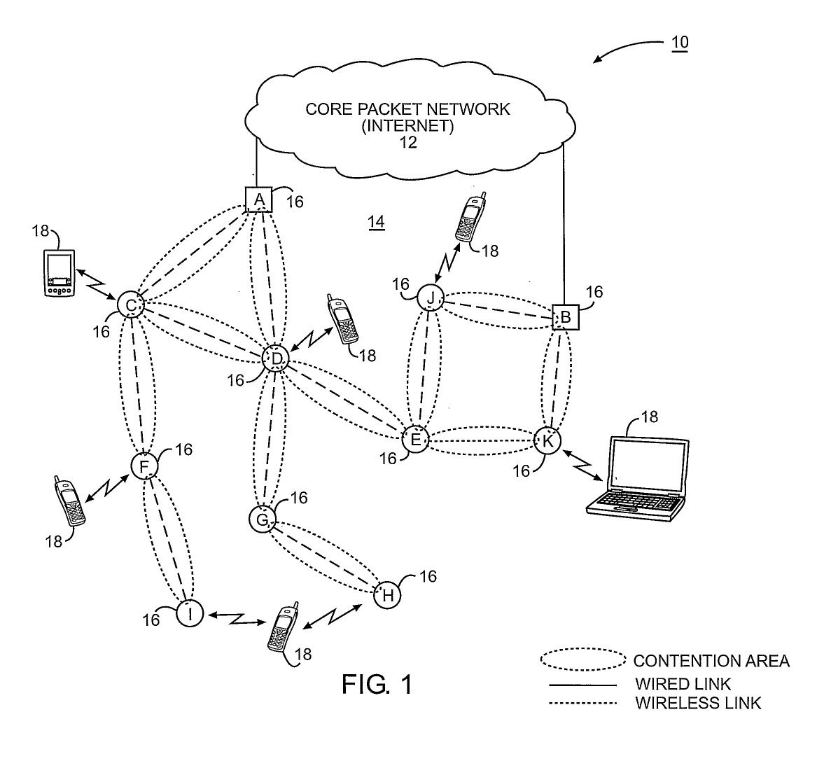

With reference to FIG. 1, a communication environment 10 is provided wherein a core packet network 12, such as the Internet, is coupled to a wireless access network 14. The wireless access network 14 is composed of numerous communication nodes 16 (A-K), which may communicate with other compatible communication nodes 16 to effectively forward communications between one or more mobile terminals 18 or between the mobile terminals 18 and an entity on or in communication with the core packet network 12. The mobile terminals 18 may take any number of forms, including mobile telephones, personal digital assistants (PDAs), and personal computers (PCs). As illustrated, communication nodes 16A and 16B provide a wired link to the core packet network 12 and a wireless link to certain other of the communication nodes 16.

For the present invention, the various communication nodes 16 in the wireless access network 14 are configured only to communicate with select compatible communication nodes 16. Communication links are established between pairs of compatible communication nodes 16; different communication links may use different modulation, space, time, and/or frequency parameters in order to minimize the potential for one communication link to interfere with other communication links.

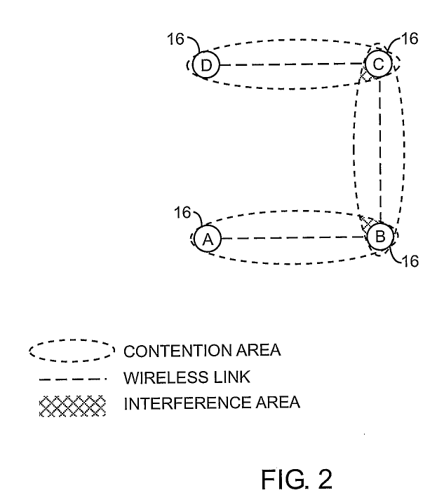

With reference to FIG. 2, four communication nodes 16 (A-D) are illustrated. Assume that communication nodes 16(A-D) have directional antennas as communication equipment capable of exploiting spatial separation to provide a wireless communication link therebetween. Other examples that will provide the required separation may be communication equipment that can switch frequency channels. Using proposed scheduling, at a time instant communication nodes 16A and 16B can form a communication link, as can communication nodes 16C and 16D without interfering with each other. Accordingly, traffic may be forwarded through communication nodes 16A, 16B, 16C, and 16D, respectively, during said transmission opportunity. Notably, proposed scheduling will prevent communication node 16A from trying to communicate directly with communication node 16D or communication node 16C during said transmission opportunity. Similarly, communication node 16B cannot communicate directly with communication node 16D during said transmission opportunity. However once this transmission opportunity has completed the links may be altered by proposed scheduling such that during the next transmission opportunity communication nodes 16C and 16B can form a communication link, as can communication nodes 16C and 16D without interfering with each other. These communication links may be established using modulation, frequency, space, and/or time based diversity parameters.

When there is a possibility of interference, scheduling within the network is provided to create non-interfering transmission opportunities between pairs of communications nodes 16. Each communication node 16 is aware of the compatible communication nodes 16 with which it can directly communicate through an associated communication link. For scheduling throughout the network, each communication node 16 is solely responsible for determining a schedule for forwarding traffic. Compatible communication nodes 16 falling within the interference area of multiple other communications nodes 16 will cooperate with one another to determine a schedule for communications over the corresponding communication link. In general, the scheduling between the compatible communication nodes 16 controls when and for how long future communications should take place. Although each communication node 16 is responsible for its own schedule, the communication node 16 must negotiate with its compatible communication node 16 to determine an appropriate schedule. Accordingly, scheduling is negotiated between a pair of compatible communication nodes 16, and dictates when a given communication node 16 will receive information from and transmit information to each compatible communication node 16. Notably, the term “transmission opportunity” is used to broadly define any time period or opportunity during which communications are possible or desired. Accordingly, transmission opportunities may be a fixed length or may dynamically vary in length based on queue sizes, quality of service requirements, communication parameters, and the like.

Since the schedule of transmission opportunities established between compatible communication nodes 16 ensure that the communications nodes 16 will not interfere with one another, and since each communication node 16 is responsible for interacting with its compatible communication node 16 for scheduling, there is no need for an overall network schedule. During scheduling, each communication node 16 must take into consideration the scheduling criteria of one or more compatible communication nodes 16. In operation, a first communication node 16 of a pair of compatible communication nodes 16 for a given communication link will send first scheduling criteria pertaining to the first communication node's scheduling availability and transmission requirements to the second communication node 16 during a previously negotiated transmission opportunity. The second communication node 16 will process the first scheduling information in light of its own scheduling criteria to determine schedule information bearing on an actual schedule for transmitting information to or receiving information from the first communication node 16. The schedule information is then sent to the first communication node 16 during a previously negotiated transmission opportunity.

This negotiation allows each of the first and second communication nodes 16 to determine the time and duration of future communications. The scheduling information is sufficient to allow the first communication node 16 to determine when and for how long to communicate with the second communication node 16, wherein the communications include the forwarding of traffic to and from the second communication node 16. Further, the second communication node 16 is also armed with sufficient information to determine when to communicate with the first communication node 16. As such, each of the compatible communication nodes 16 has determined its own schedule to communicate with each other.

The compatible communication nodes 16 associated with each communication link will carry out a similar process. Notably, many communication nodes 16 will be associated with one or more compatible communication nodes 16, and will need to take into consideration the scheduling criteria associated with multiple compatible communication nodes 16. The schedules provide transmission opportunities for future negotiations, as well as for the forwarding of traffic to facilitate communications with one or more mobile terminals 18. The negotiation process is continually repeated to ensure a transmission opportunity is always available for communications over a given communication link. Accordingly, each communication node 16 determines its own schedule based on negotiations with compatible communication nodes 16 with which it communicates over non-interfering transmission opportunities.

Assume the set of communication nodes 16 in the wireless access network 14 is represented as N={n₀, n₁, . . . nₖ}. Each communication node 16 nᵢ can identify compatible communication nodes 16 with which it may directly communicate. For communication node 16 nᵢ the compatible nodes may be represented as a set NBᵢ={nₚ, n_{q}, . . . }, wherein communication nodes 16 nₚ and n_{q} are compatible communication nodes 16 for communication node 16 nᵢ. Upon initialization, a communication node 16 will attempt to gather information about its compatible nodes 16 and try to communicate with them in order to determine its compatible nodes 16. Once communication nodes 16 have established themselves as being compatible with each other, each pair of compatible communication nodes 16 will be able to communicate for a limited period of time, which is sufficient to exchange enough messages to establish the repeating process of scheduling as discussed above in general and discussed in greater detail below.

In one embodiment, a particular communication node's schedule is a set of contiguous transmission opportunities in which communications to or from a compatible communication node 16 may take place over a given communication link. The set of contiguous transmission opportunities may be represented as SC={S₀, S₁, S₂, . . . , Sⱼ}={t₀, t₁, t₂, . . . }, where to is the start of the next transmission opportunity as well as the end of the present transmission opportunity; t₁ is the end of transmission opportunity 0 and the start of transmission opportunity 1, and so on. Where transmission opportunity S₁ occurs before Sⱼ, this implies that the corresponding start time values are such that t₁<tⱼ. A given schedule will cover only a finite period of time, and the current time T is never greater than t₀.

Pairs of compatible communication nodes 16 will have corresponding schedules when the two communication nodes 16 are scheduled to communicate. For example, if in a schedule for communication node 16 nᵢ, an entry for any time instant indicates that it is to communicate with a compatible communication node 16 nⱼ, then there is a corresponding entry for the same time instant in the schedule of communication node 16 nⱼ that indicates it is to communicate with communication node 16 nᵢ. When compatible communication nodes 16 negotiate with each other to reserve transmission opportunities for communications, the schedule for a given transmission opportunity may be represented as Sᵢ={tᵢ, nᵢ, pᵢ, sᵢ, cᵢ}, where tᵢ is the start time for transmission opportunity i, nᵢ is the corresponding compatible communication node 16, pᵢ represents communication parameters used to facilitate communications during the transmission opportunity, sᵢ represents a set of quality of service (QoS) attributes, and cᵢ is a list of communication nodes 16 that may contend for the transmission opportunity. The parameters nᵢ, pᵢ, sₒ, and cᵢ may equal a null for times when there are no compatible nodes 16 with which to communicate.

Since a transmission opportunity begins a finite amount of time after the negotiations to reserve a transmission opportunity, a function that computes the expected data to be exchanged in light of the length of data queues, QoS markers, and other historical information may be used when negotiating the number of transmission opportunities required, the size of one transmission opportunity, and the frequency at which communications may take place. By using suitable policies, such as by capping the maximum size or number of transmission opportunities of the compatible communication node 16, and allowing compatible neighbors 16 an equal chance to book transmission opportunities, the communication node 16 can ensure that the respective scheduling is fair. Similar restrictions may be used to meet QoS requirements such as per-hop delay, where per-hop delay in servicing a particular queue for a compatible communication node 16 may be computed by a designated service discipline. The service discipline may provide information regarding the priority of different queues as well as the relative wait times between queues having the same priority. In another instance, the frequency at which transmission opportunities are booked for communicating with compatible communication nodes 16 may be increased and the transmission opportunity sizes may be reduced when QoS requirements dictate low delays or latency. Alternatively, frequency of booking may be decreased and transmission opportunity sizes increased when higher throughput is required. Yet another example would be controlling reservations of transmission opportunities proportionally based on a ratio of data expected on a particular queue with respect to the data on other queues. Those skilled in the art will recognize various techniques for establishing policies to control the way in which scheduling is implemented.

Notably, each of the communication nodes 16 may have any number of queues, wherein each queue is associated with traffic to be sent to or received from a particular communication node 16, endpoint, or other entity. Further, queues for a given entity or multiple entities may be established for different QoS levels. The scheduling information used to create schedules and provided between compatible communication nodes 16 may take into consideration the various queues and the associated policies dictating the speed at which the information in the respective queues must be processed with respect to other queues. As such, different queues may have different priorities, and the negotiations between compatible communication nodes 16 will address the required priorities.

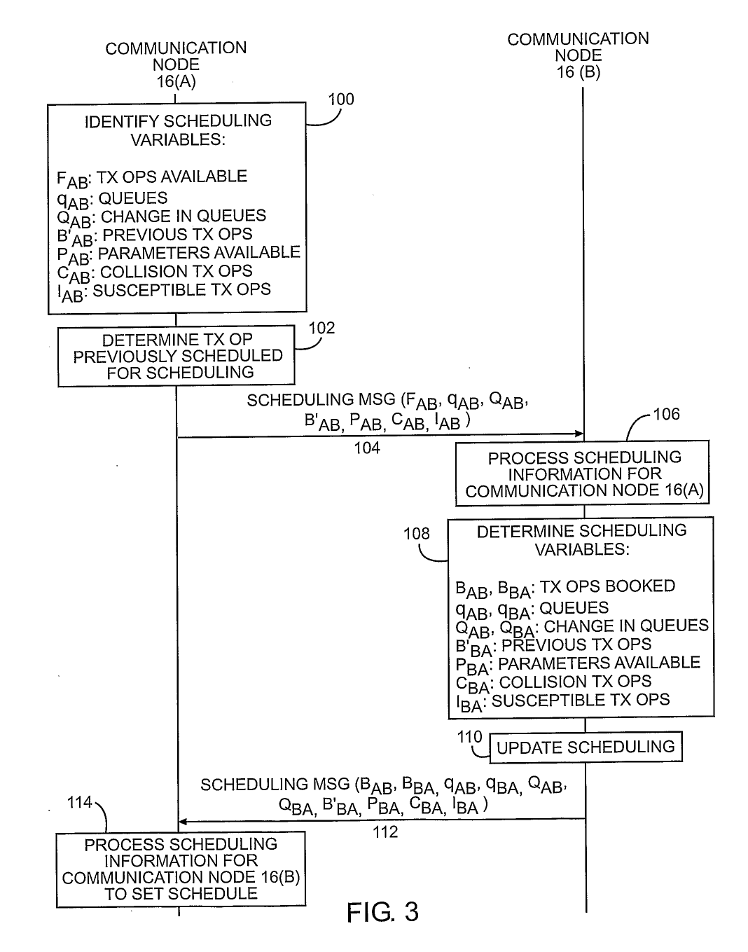

With reference to FIG. 3, an exemplary negotiation process is illustrated between compatible communication nodes 16A and 16B. Various types of scheduling information will be generated and processed during the negotiations. The following illustrates an exemplary scheduling function B_{pq}, where p represents a communication node 16 and q represents a compatible communication node 16. The scheduling function B_{pq} may be represented as follows:

B_{pq}=β_{pq}(q_{pq},q_{qp},F_{pq},F_{qp},B′_{pq},B′_{qp},Q_{pq},Q_{qp},P_{pq}), Eq. 1

where q_{pq} is the size of a particular queue for data forwarded from communication node 16 p to communication node 16 q, F_{pq} is a transmission opportunity in the future that is available to be scheduled for data transfer from communication node 16 p to communication node 16 q, B′_{pq} is a transmission opportunity in the past that was booked for data transfer from communication node 16 p to communication node 16 q, Q_{pq} is the change in the queue size for data from communication node 16 p to communication node 16 q, and P_{pq} represents communication parameters available for use in the transmission opportunity for data transfer from communication node 16 p to communication node 16 q. The communications parameters P_{pq} may include modulation, space, time, and/or frequency parameters in order to minimize the potential for one communication link to interfere with other communication links.

Initially, the process begins when communication node 16A identifies its scheduling variables corresponding to what has been scheduled and future scheduling requirements with respect to communication node 16B (step 100). In this instance, the scheduling variables include the transmission opportunities (TX OPs) available for communications between the compatible communication nodes 16A and 16B, F_{AB}; the relative length of the queue storing information to be transmitted from communication node 16A to 16B, q_{AB}; the change in the queue size since the last negotiation, Q_{AB}; transmission opportunities in the past that have been scheduled for transferring information from communication node 16A to 16B, B′_{AB}; and the communication parameters available for use between communication nodes 16A and 16B, P_{AB}. If such information is available, scheduling variables may include information on transmission opportunities where past collisions have occurred, CAB; or transmission opportunities where interference during available future transmission opportunities may be likely, I_{AB}. All of the scheduling variables are deemed necessary or beneficial to aid communication node 16B in the negotiation process.

The communication node 16A will then determine the next transmission opportunity available for transmitting the scheduling variables to communication node 16B (step 102). Notably, this transmission opportunity will have been scheduled during prior negotiations between communication nodes 16A and 16B. When the transmission opportunity occurs, the communication node 16A will send a scheduling message with the scheduling variables to communication node 16B (step 104). Communication node 16B will then process the scheduling information received from communication node 16A in light of its own scheduling variables (step 106) and determine additional scheduling variables (step 108). These additional scheduling variables may be scheduling information used to update the schedule of communication node 16B, as well as information useful for communication node 16A. Notably, communicate node 16B may be configured to run the scheduling functions to determine B_{AB} and B_{BA}. These scheduling functions may include the following:

$${B}_{AB} = {β}_{AB} ( {q}_{AB} , {q}_{BA} , {F}_{AB} , {F}_{BA} , {B}_{AB}^{′} , {B}_{BA}^{′} , {Q}_{AB} , {Q}_{BA} , {P}_{AB} ) \\ {B}_{BA} = {β}_{BA} ( {q}_{AB} , {q}_{BA} , {F}_{AB} , {F}_{BA} , {B}_{AB}^{′} , {B}_{BA}^{′} , {Q}_{AB} , {Q}_{BA} , {P}_{BA} ) \\ {I}_{BA} = α ( {I}_{AB} , {C}_{AB} ) \qquad Eq . 2$$

Accordingly, communication node 16B will update its schedule (step 110) and send any pertinent scheduling variables to communication node 16A in a scheduling message (step 112).

Notably, communication node 16B will use the scheduling variables from communication node 16A and its own scheduling variables to determine transmission opportunities to book for communications from communication node 16A to communication node 16B, B_{AB}, as well as transmission opportunities for communications from communication node 16B to communication node 16A, B_{BA}. Information on the respective queue sizes, q_{AB} and q_{BA}, as well as the change in the respective queue sizes, Q_{AB} and Q_{BA} may also be provided, along with an identification of previously assigned transmission opportunities for communications from communication node 16B to communication node 16A, B′_{BA}. The communication parameters for communications from communication node 16B to communication node 16A are provided, P_{BA}, as well as information bearing on transmission opportunities in which collisions have occurred (C_{BA}) or interference in future available transmission opportunities (I_{BA}) may be likely.

The communication node 16A will then receive the scheduling variables provided by communication node 16B and process the scheduling information from communication node 16B to determine its schedule (step 114). At this point, communication node 16A is apprised of the times during which communication node 16B wants to communicate with communication node 16A, and will then update its scheduling accordingly. Communication node 16A has also been afforded transmission opportunities during which it can communicate to communication node 16B. At this point, both communication node 16A and communication node 16B have established an updated schedule for transmitting data back and forth at predefined transmission opportunities using predefined communication parameters, which may be based on the scheduling negotiations or may be preset depending on physical configurations.

In another embodiment of the negotiation procedure, a three-way handshake may be used, when the communication nodes 16A and 16B do not have sufficient trust. The semantics of the contents of the messages will in that case be such that the first message is a proposal for time reservation for communications from communication node 16A to communication node 16B. A second message from communication node 16B to communication node 16A can carry reserved transmit opportunities from communication node 16A to communication node 16B as well as a proposal of time reservation from communication node 16B to communication node 16A. Finally the third and last message will be from communication node 16A to communication node 16B where A will indicate the reserved transmit opportunities from communication node 16B to communication node 16A. Using such a sequence both communication nodes 16A and 16B can maintain greater control over reservation in each direction. Another refinement of negotiation may include a repetition parameter. In this case, a communication node 16 may request several (a fixed number, or a range of numbers) of transmit opportunities in a specific time interval of a particular size (or range of sizes). In both cases above, the specific contents of the message will be similar to those in FIG. 3.

In order to convey information bearing on free or scheduled transmission opportunities, the communication nodes 16 may use relative time, in embodiments where the communication nodes 16 have free-running, independent clocks. The relative time may be calculated with respect to a reference point, which may be a global time instant that the pair of compatible communication nodes 16 shares and marks in their respective local clocks as a point from which to compute time intervals. This common point in time can be generated between the pair of communication nodes 16 by a simple message exchange, wherein the sender marks the point at which it sent a packet and the receiver marks the point at which it received it.

In one embodiment of the present invention, the communication nodes 16 do not have clocks that are tied to a central network clock. As such, the clocks in the various communication nodes 16 will drift. To avoid scheduling issues associated with clock drift, the present invention may use transmission opportunities that are bounded as a function of the maximum drift of the individual clocks in the respective communication nodes 16. As such, scheduling relies on the transmission opportunities relative to the compatible communication nodes 16. Given a worst-case variation in clocks, the scheduler in any given communication node 16 is able to bound the variation in each transmission opportunity with each of its compatible communication nodes 16 independently of the other compatible communication nodes 16. By periodically determining a fresh reference point, loss of synchronization is avoided. Notably, the present invention does not require the communication nodes 16 to ever exchange their respective notions of time, hence avoiding de-synchronization with respect to other communication nodes 16.

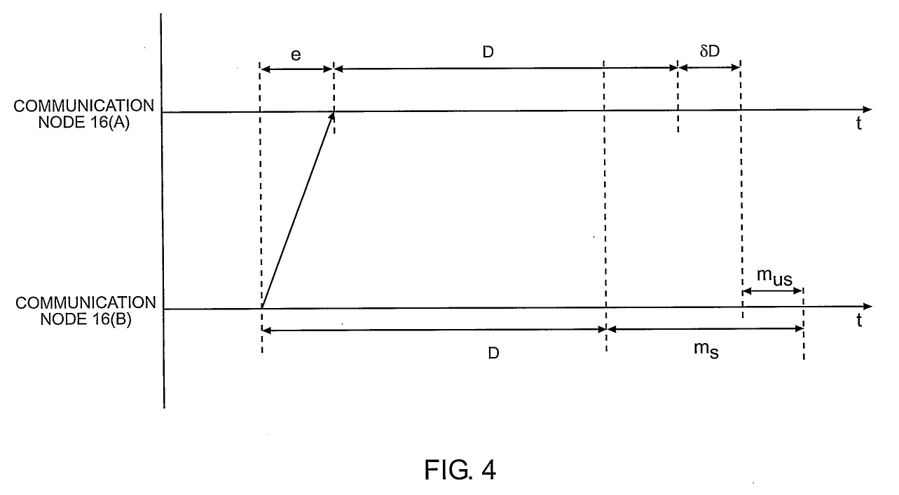

The maximum time between negotiations between two compatible communication nodes 16 can be calculated as follows, and is illustrated in FIG. 4. These calculations are based on a message being sent from communication node 16B to communication node 16A. If ε is the error in timing when the message is exchanged, and mₛ and mᵤₛ are deemed to be the minimal size of a transmission opportunity and the minimal sized transmission opportunity, respectively, that can be used for communications, then:

$${m}_{us} \geq ( D + {m}_{u} ) - ( e + D + δ D ) \\ D \leq \frac{{m}_{us} - {m}_{u} - e}{δ} \qquad Eq . 3$$

where D is the maximum time before which two communication nodes 16 must negotiate, and δ is the maximum time that the clocks on the two compatible communication nodes 16 can vary in one unit of time.

Notably, the scheduling occurs between all nodal pairs throughout the wireless access network 14. At any given time, all of the data required to be transferred throughout the network has been scheduled or will soon be scheduled automatically as each of the pairs of compatible communication nodes 16 cooperate with one another to negotiate their respective communication needs. These communications will bear the requisite QoS parameters established through policies implemented on each of the individual communication nodes 16. Once schedules have been negotiated, traffic is simply forwarded from one communication node 16 to another on its way toward an appropriate destination. The communication nodes 16 do not need to be synchronized to a central network clock, nor do they need to rely on a central scheduling entity for determining their respective schedules for receiving information from or transmitting information to various compatible communication nodes 16.

In the above examples, it has been assumed that only one communication link is available at any given time between compatible communication nodes 16. Different configurations in the communication nodes 16 may provide for multiple communication links, which do not interfere with each other, between a given pair of compatible communication nodes 16. In this instance, a given communication node 16 may keep different schedules for different communication links. During negotiations for scheduling, the participating communication node 16 should endeavor to create the different schedules in a serial fashion to avoid replicate scheduling. Otherwise, the various schedules need to be considered together in an effort to ensure the scheduling process is efficient, accurate, and lacking redundancy.

In the above discussions, compatible communication nodes 16 were established in pairs and communicate over one or more dedicated communication links. The concepts of the present invention can be extended to groups of compatible communication nodes 16 that have three or more compatible communication nodes 16. In this configuration, a given data packet is allowed to travel across multiple ones of the compatible communication nodes 16, in other words take multiple hops, within a given transmission opportunity. Further, data packets from multiple ones of the compatible communication nodes 16 may be sent to another one of the compatible communication nodes 16 during a given transmission opportunity, and vice versa. The communication links between the various compatible communication nodes 16 may be configured as necessary to minimize interference and collisions.

Scheduling is essentially the same as described above, except that the participating compatible communication nodes 16 operate such that the data packets are transmitted and received as necessary within the given transmission opportunity. To avoid conflicts in scheduling, various steps may be taken. For example, in one embodiment one communication node 16 of the group of compatible communication nodes 16 will initiate negotiations, wherein the compatible communication nodes 16 are still responsible for their own schedules but will negotiate as the initiating compatible communication node 16 dictates. Each of the negotiations should be initiated and completed before another one starts. Alternatively, any of the compatible communication nodes 16 may initiate negotiations. Negotiations with the responding compatible communication node 16 will take place on a first-come, first-serve basis, wherein each negotiation is initiated and finished prior to initiating a subsequent negotiation.

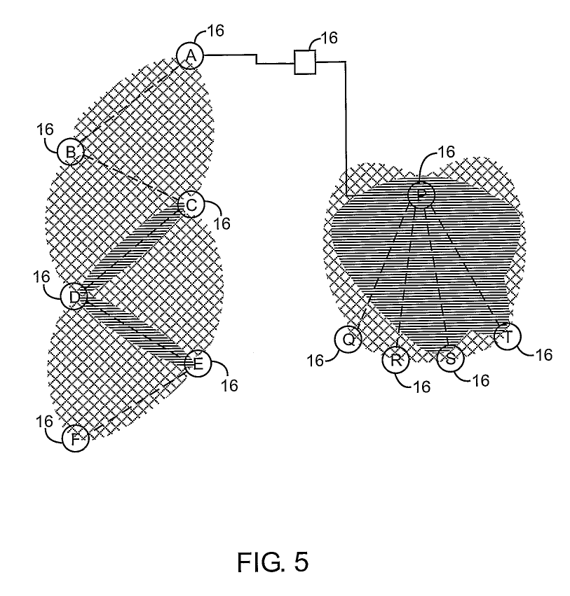

Turning now to FIG. 5, a block representation of a communication environment is shown to illustrate exemplary ways in which compatible communication nodes 16 may be grouped. For compatible communication nodes 16A-16F, data packets may be transmitted from communication node 16A to communication node 16F within a given transmission opportunity, assuming each of the compatible communication nodes 16A-16F have negotiated an appropriate schedule. Similarly, communication nodes 16P-16T provide a compatible group of communication nodes 16 wherein multiple data packets may be sent between communication nodes 16P and one or more of communication nodes 16Q-16T in the same transmission opportunity, and vice versa. For these embodiments, the communication parameters are simply modified to allow the appropriate communications between the compatible communication nodes 16 within a given transmission opportunity, unbeknownst to other communication nodes 16 that are not compatible with those in the group of compatible communication nodes 16.

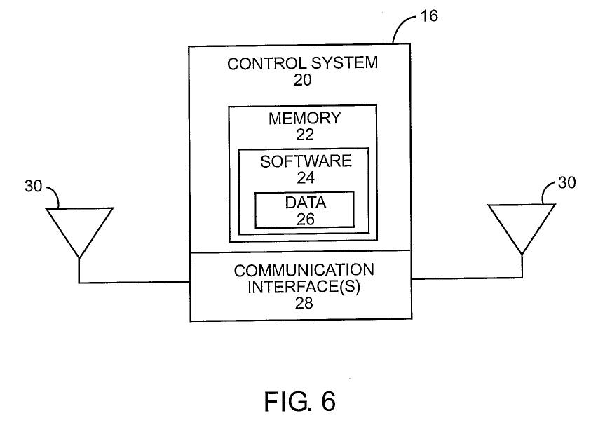

With reference to FIG. 6, a block representation of a communication node 16 is illustrated. The communication node 16 may include a control system 20 associated with sufficient memory 22 for the requisite software 24 and data 26 to operate as described above. The control system 20 is also associated with one or more communication interfaces 28, which are capable of implementing the various communication parameters, as described above, to facilitate communication links with compatible communication nodes 16. In the illustrated embodiment, the communication interfaces 28 may be associated with one or more communications links 30 to provide communications with one or more compatible communication nodes 16.

Those skilled in the art will recognize improvements and modifications to the preferred embodiments of the present invention. All such improvements and modifications are considered within the scope of the concepts disclosed herein and the claims that follow.

What is claimed is:

1. A method comprising:
exchanging scheduling information with at least one compatible communication node in a wireless communication network;
determining a communication schedule for communications with the at least one compatible communication node based on the scheduling information; and
communicating with the at least one compatible communication node based on the communication schedule, wherein communication nodes in the wireless communication network independently determine communication schedules with other compatible communication nodes.

2. The method of claim 1 wherein communications with each of the at least one compatible communication node are established over at least one corresponding communication link, which does not contend with other communication links in the wireless communication network during scheduled communications.

3. The method of claim 1 wherein communications with the at least one compatible communication node are established over a plurality of communication links, which do not contend with each other or with other communication links in the wireless communication network during scheduled communications.

4. The method of claim 1 wherein the at least one compatible communication node is a plurality of compatible communication nodes and at least one communication schedule is established for controlling communications with each of the plurality of compatible communication nodes.

5. The method of claim 4 wherein scheduling embodied in the at least one communication schedule for each of the plurality of compatible communication nodes within the at least one communication schedule is provided in serial fashion.

6. The method of claim 1 wherein the communication schedule provides a schedule for forwarding traffic to or from the at least one compatible communication node.

7. The method of claim 1 wherein the communication schedule provides a schedule for exchanging scheduling information with the at least one compatible communication node.

8. The method of claim 1 wherein the communication schedule provides a schedule for forwarding traffic to or from the at least one compatible communication node and for exchanging scheduling information with the at least one compatible communication node.

9. The method of claim 1 wherein the communication nodes in the wireless communication network maintain independent clocks, which are not synchronized with one another.

10. The method of claim 1 further comprising providing a plurality of queues for traffic to send to the at least one compatible communication node and corresponding to a plurality of quality of service levels, wherein determining the communication schedule provides scheduling sufficient to ensure communications with the at least one compatible communication node occur according to an appropriate quality of service.

11. The method of claim 1 wherein the communication schedule defines transmission opportunities during which communications with the at least one compatible communication node are scheduled to take place.

12. The method of claim 11 wherein the transmission opportunities are variable in length.

13. The method of claim 12 wherein the lengths of the transmission opportunities are based on communication or scheduling related parameters.

14. The method of claim 11 wherein certain packets are scheduled to hop through a plurality of compatible communication nodes during a given transmission opportunity.

15. The method of claim 11 wherein communications with a plurality of compatible communication nodes are scheduled to occur during a given transmission opportunity.

16. The method of claim 1 wherein the scheduling information comprises communication parameter information, and the communication schedule is determined, in part, based on the communication parameter information.

17. The method of claim 1 wherein the scheduling information comprises at least one of collision information pertaining to past transmission opportunities and susceptibility information pertaining to future available transmission opportunities that may likely be subjected to interference.

18. A communication node comprising:
at least one wireless communication interface; and
a control system associated with the at least one wireless communication interface and adapted to:
exchange scheduling information with at least one compatible communication node in a wireless communication network;
determine a communication schedule for communications with the at least one compatible communication node based on the scheduling information; and
communicate with the at least one compatible communication node based on the communication schedule, wherein communication nodes in the wireless communication network independently determine communication schedules with other compatible communication nodes.

19. The communication node of claim 18 wherein communications with each of the at least one compatible communication node are established over at least one corresponding communication link, which does not contend with other communication links in the wireless communication network during scheduled communications.

20. The communication node of claim 18 wherein communications with the at least one compatible communication node are established over a plurality of communication links, which do not contend with each other or with other communication links in the wireless communication network during scheduled communications.

21. The communication node of claim 18 wherein the at least one compatible communication node is a plurality of compatible communication nodes, and at least one communication schedule is established for controlling communications with each of the plurality of compatible communication nodes.

22. The communication node of claim 21 wherein scheduling embodied in the at least one communication schedule for each of the plurality of compatible communication nodes within the at least one communication schedule is provided in serial fashion.

23. The communication node of claim 18 wherein the communication schedule provides a schedule for forwarding traffic to or from the at least one compatible communication node.

24. The communication node of claim 18 wherein the communication schedule provides a schedule for exchanging scheduling information with the at least one compatible communication node.

25. The communication node of claim 18 wherein the communication schedule provides a schedule for forwarding traffic to or from the at least one compatible communication node and for exchanging scheduling information with the at least one compatible communication node.

26. The communication node of claim 18 wherein the communication nodes in the wireless communication network maintain independent clocks, which are not synchronized with one another.

27. The communication node of claim 18 further comprising providing a plurality of queues for traffic to send to the at least one compatible communication node and corresponding to a plurality of quality of service levels, wherein determining the communication schedule provides scheduling sufficient to ensure communications with the at least one compatible communication node occur according to an appropriate quality of service.

28. The communication node of claim 18 wherein the communication schedule defines transmission opportunities during which communications with the at least one compatible communication node are scheduled to take place.

29. The system of claim 28 wherein the transmission opportunities are variable in length.

30. The system of claim 29 wherein the lengths of the transmission opportunities are based on communication or scheduling related parameters.

31. The communication node of claim 28 wherein certain packets are scheduled to hop through a plurality of compatible communication nodes during a given transmission opportunity.

32. The communication node of claim 28 wherein communications with a plurality of compatible communication nodes are scheduled to occur during a given transmission opportunity.

33. The system of claim 18 wherein the scheduling information comprises communication parameter information, and the communication schedule is determined, in part, based on the communication parameter information.

34. The system of claim 18 wherein the scheduling information comprises at least one of collision information pertaining to past transmission opportunities and susceptibility information pertaining to future available transmission opportunities that may likely be subjected to interference.
